(19) United States
(12) Patent Application Publication
(10) Pub. No.: US 2008/0133836 A1
(43) Pub. Date: Jun. 5, 2008

(54) APPARATUS, SYSTEM, AND METHOD FOR A DEFINED MULTILEVEL CACHE

(76) Inventors: Robert M. Magid, Monroe Township, NJ (US); Louis M. Szaszy, Easton, PA (US)

Correspondence Address: Kunzler & McKenzie, 8 EAST BROADWAY, SUITE 600, SALT LAKE CITY, UT, 84111, US

(21) Appl. No.: 11/565,340

(22) Filed: Nov. 30, 2006

(51) Int. Cl. G06F 12/08

(52) U.S. Cl. 711/122; 711/E12.024

(57) ABSTRACT

An apparatus, system, and method are disclosed for a defined multilevel cache. A cache definition module is configured to externally define a plurality of cache levels from a cache definition file. Each cache level comprises a level keyword, a storage quantity of a storage device, and at least one token. Each level keyword of a cache level specifies an order that the cache level is filled. The interface module is configured to interface between each application program and the plurality of cache levels such that each application program sees the plurality of cache levels as a virtual single cache entity. The storage module configured to store the data from each application program to the plurality of cache levels. The storage module may store data beginning with a cache level with a lowest order level keyword and with a token of the application program.

### BACKGROUND OF THE INVENTION

1. Field of the Invention

This invention relates to multilevel caching and more particularly relates to defining multilevel caches.

2. Description of the Related Art

Enterprise data processing systems typically include one or application programs that process data from one or more storage subsystems. For example, an application program may execute on a server. The server may store data for the application program on a storage subsystem that includes one or more redundant array of independent disk (RAID) storage controllers that each manages one or more storage devices such as hard disk drives. The application program may retrieve data from one or more storage devices, process the data, and write the processed data to the storage devices.

Because retrieving data from the storage subsystem and writing the data to the storage subsystem may take significant time, it is often desirable to cache the data in a cache. The cached data typically may be accessed with a much lower latency. For example, a database recovery application program may cache data used in recovering a database in a cache with a lower access latency than the storage subsystem.

The cache is typically created from a main memory of a server. Often an operating system may allocate one or more address blocks from the main memory for caching data. The application program may use the allocated address blocks to cache data to reduce the storage latency for the data over storing the data in the storage subsystem.

Unfortunately, the main memory of the server may be insufficient to cache sufficient data for the application program. In addition, a plurality of application programs may collectively be unable to cache their data in the cache. As a result, one or more application programs may need to store some or all of their data in the storage subsystem. Yet storing the data to the storage subsystem increases the latency of the data, decreasing the performance of the application programs.

From the foregoing discussion, it is apparent that there is a need for an apparatus, system, and method that expands a cache for application programs. Beneficially, such an apparatus, system, and method would extend the memory space available as caches for application programs and increase application program performance.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a computer in accordance with the present invention;

FIG. 2 is a schematic block diagram illustrating one embodiment of an cache definition apparatus in accordance with the present invention; and

FIG. 3 is a schematic flow chart diagram illustrating one embodiment of a multilevel cache definition method of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

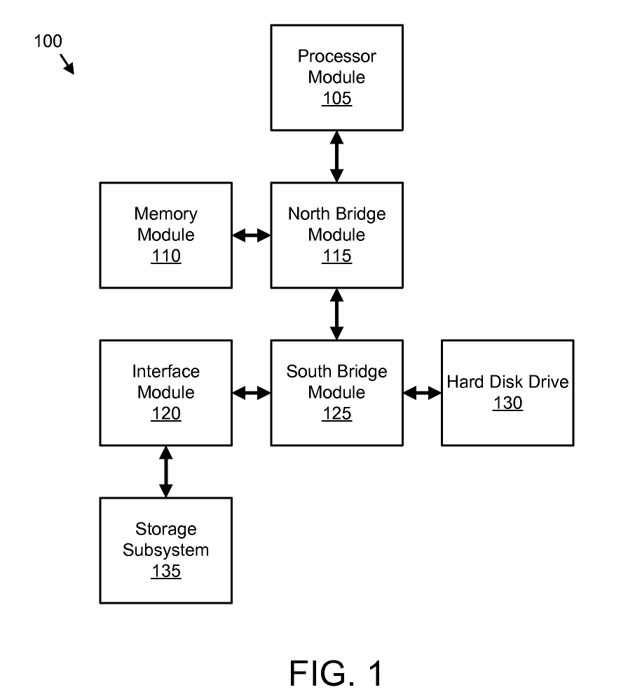

FIG. 1 depicts a schematic block diagram illustrating one embodiment of a computer 100 in accordance with the present invention. The computer comprises of a processor module 105, memory module 110, north bridge module 115, interface module 120, south bridge module 125, hard disk drive 130 and a storage subsystem 135.

The processor module 105 executes software instructions and processes data. The memory module 110 stores the software instructions and processes data. In one embodiment, the memory module 110 comprises a printed circuit board that holds memory chips. The memory module 110 may be configured as one or more 184-pin DIMM modules for DDR SDRAM, 168-pin DIMM modules for SDRAM or DRAM chips, and/or Rambus modules for RDRAM. Because of space limitations, laptops may use small outline DIMMs (SODIMMs). SIMM and Rambus modules are installed in pairs, whereas a single DIMM can be used.

In one embodiment, a portion of the memory module 110 may be organized as a dataspace for an application program. The dataspace may be addressed using 32-bit addresses. In addition to the memory module 110, data may be stored on the hard disk drive 130 and/or on the storage subsystem 135. Data stored outside of the dataspace may be 64-bit addressable storage in the memory module 110, private memory, and temporary files stored on the hard disk drive 130.

As is known to one skilled in the art, communications between components connected to a motherboard may be through the motherboard's core logic chipset, which is composed of two chips, the north bridge module 115 and the south bridge module 125. The north bridge module 115 resides near a processor socket, and serves as an intersection connecting the processor module 110, memory module 110, and the south bridge module 125.

The south bridge module 125 allows plugged-in devices such as network cards or modems to communicate with the processor module 105 and the memory module 110. The south bridge 125 handles most of a motherboard's “value-added” features, such as the IDE controller, USB controller, and Ethernet connections. The processor module 105 may store data to the hard disk drive 130 and the storage subsystem 135 through the south bridge 135. The storage subsystem 135 may be RAID system, a magnetic tape library, or the like.

In the past, only the dataspace of the memory module 110 has been available for caching data for application programs. Customers have asked for more flexibility in configuration the cache due to environmental constraints such as internally imposed limitations on virtual storage/data space utilization. In the extreme case, some customers are unable to use these application programs that employ caching when cached data volumes and access patterns require the use of more virtual storage/dataspaces than the memory module 110 can facilitate.

The present invention provides customers with the ability to externally control and choose from a combination of available cache management mechanisms provided by the tools. As a result, the tools will enable the highest levels of performance based upon the customer's environment, preferences, and installed technology.

When implemented as a single and reusable technology, the invention provides a layer of transparency between the tools and the underlying technology used for cache management. This will result in faster delivery of tools to exploit next generation caching technologies. It also minimizes development/enhancement and ongoing maintenance costs with a single set of source code.

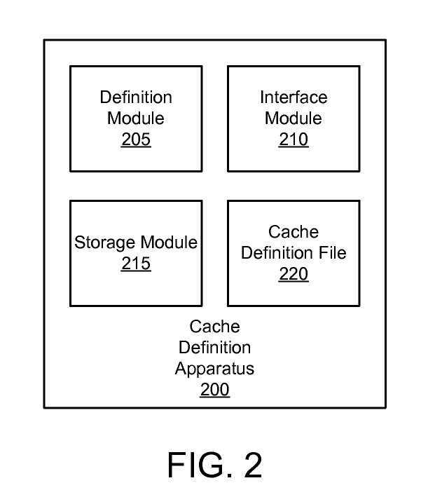

FIG. 2 shows a schematic block diagram illustrating one embodiment of a cache definition apparatus 200. The apparatus 200 comprises a definition module 205, an interface module 210, and a storage module 215. The description of the apparatus 200 refers to elements of FIG. 1, like numbers referring to like elements. In one embodiment, the definition module 205, interface module 210, and storage module 215 comprise one or more software processes of one or more computer readable programs.

The definition module 205 is configured to externally define a plurality of cache levels from a cache definition file 220. Each cache level comprises a level keyword, a storage quantity of a storage device, and at least one token. Each specified storage device is distinct from all other storage devices. The specified storage devices may include the memory module 110, the hard disk drive 130, and the storage subsystem 135. However, one skilled in the art will recognize that other types and classes of storage devices may be used.

Each level keyword of a cache level specifies an order that the cache level is filled. For example, a first cache level may be designated level “1,” a second cache level may be designated level “2,” and a third cache level may be designated level “3.” The numeral for each cache level may indicate the order in which the cache level is filled. Each token associates a cache level with an application program. For example, the token “DB1A” may associate the cache level with a first database application program.

The interface module 210 is configured to interface between each application program and the plurality of cache levels such that each application program sees the plurality of cache levels as a virtual single cache entity. The virtual cache entity for each application program defines, stores, and retrieves multiple instances of data where each instance is associated with a token and each instance can have a specific data structure. Continuing the example above, the first database application program may store a data instance to the virtual single cache entity, although the data may actually be stored to the memory module 110, the hard disk drive 130, and/or the storage subsystem 135.

The storage module 215 is configured to store the data instance from each application program to the plurality of cache levels. The storage module 215 may store the data instance beginning with a cache level with a lowest order level keyword and with the token of the data instance from the application program. Continuing the above example, the storage module 215 may store data from the first application program to the first cache level “1” if the token for the first cache level is “DB1A.” The storage module 215 may store the data instance to a cache level with higher order level keyword and the token of the application program when the cache level with a lower order keyword is filled.

In one embodiment, the storage module 215 is further configured to share the data instance in the cache levels stored by a first application program with a second application program. The storage module 215 shares the data instance by passing the token of the first application program to the second application program wherein the second application program may access the data instance of the cache levels with the token of the first application program.

In an alternate embodiment, the cache definition apparatus 200 is configured such that each data instance further comprises a structure type that defines a structure of the data instance. The structure type may be selected from a linked list, a stack and a flat file structure type.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

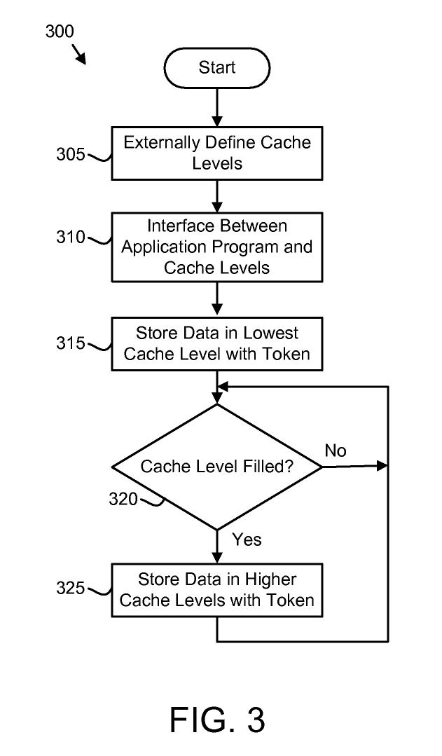

FIG. 3 is a schematic flow chart diagram illustrating one embodiment of a multilevel cache definition method 300 of the present invention. The method 300 depicted in FIG. 3 substantially includes the steps to carry out the functions presented above with respect to the operation of the described computer and apparatus of FIGS. 1 and 2 In one embodiment, the method 300 is implemented with a computer program product comprising a computer readable medium having a computer readable program. The computer 100 may execute the computer readable program.

The method 300 begins and the definition module 205 externally defines 305 a plurality of cache levels from a cache definition file 220. Each cache level comprises a level keyword, a storage quantity of a storage device, and at least one token. The cache definition file 220 may be configured as a delimited flat file listing a storage device, a level keyword, a storage quantity in megabytes (MB), and a token name followed by a delimiter such as an ENTER for each cache level. Each specified storage device is distinct from all other storage devices.

The interface module 210 interfaces 310 between each application program and the plurality of cache levels 310 such that each application program sees the plurality of cache levels as a virtual single cache entity. For example, a first and second application program may each interface with the virtual cache entity through the interface module, although data instances for each application program may be stored in different cache levels.

The storage module 215 stores 315 the data instances from each application program to the plurality of cache levels. Each data instance may be associated with a token and have a specific data structure. The storage module 215 may store 315 data instances beginning with a cache level with a lowest order level keyword and with the token of the data instance of the application program. Continuing the above example, the storage module 215 may store 315 data instances from the first application program to the hard disk drive 130 configured as a cache level with a level keyword “9” while storing 315 data instances from the second application program to the memory module 110 configured as a cache level with a level keyword “2.”

In one embodiment, the storage module 215 determines 320 if a cache level is filled. For example, the storage module 215 may determine 320 if the specified storage quantity of the hard disk drive 130 configured as the cache level with the level keyword “9” is filled with data instances. If the storage module 215 determines 320 that the cache level is not filled, the storage module 215 continues storing data instances to the cache level.

If the storage module 215 determines 320 that the cache level is filled, storage module 215 may store 325 the data instances to a cache level with higher order level keyword and the token of the application program. Continuing the example, above, the storage module 215 may store 325 data instances for the first application program in the storage subsystem 135 configured as a cache level with a level keyword “10” if the cache level with the level keyword “9” is filled with data instances.

The method 300 defines the multilevel cache so that additional cache is seamlessly and transparently available to the application programs. Thus the application programs may employ larger quantities of cache without changes to the application programs.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer useable medium having a computer readable program, wherein the computer readable program when executed on a computer causes the computer to:
externally define a plurality of cache levels from a cache definition file wherein each cache level comprises a level keyword, a storage quantity of a storage device, and at least one token, wherein each specified storage device is distinct from all other storage devices, each level keyword of a cache level specifies an order that the cache level is filled, and each token associates a cache level with an application program of a plurality of application programs;
interface between each application program and the plurality of cache levels such that each application program sees the plurality of cache levels as a virtual single cache entity and in which the virtual single cache entity for each application program defines, stores and retrieves multiple instances of data where each instance is associated with a token and each instance can have a specific data structure;
store the data instance from each application program to the plurality of cache levels beginning with a first cache level with a lowest order level keyword and with the token for the application program; and
store the data instance to a cache level with higher order level keyword and the token of the application program when a cache level with a lower order level keyword is filled.

2. The computer program product of claim 1, wherein the computer readable code is further configured to cause the computer to share the data instance in the cache levels stored by a first application program with a second application program by passing the token of the data instance from the first application program to the second application program, wherein the second application program may access the data instance in the cache levels with the token of the first application program.

3. The computer program product of claim 1, wherein each data instance further comprises a structure type that defines a structure of that data instance.

4. The computer program product of claim 3, wherein the structure type is selected from a linked list, a stack, and a flat file structure type.

5. An apparatus for a defined multilevel cache, the apparatus comprising:
a definition module configured to externally define a plurality of cache levels from a cache definition file wherein each cache level comprises a level keyword, a storage quantity of a storage device, and at least one token, wherein each specified storage device is distinct from all other storage devices, each level keyword of a cache level specifies an order that the cache level is filled, and each token associates a cache level with an application program of a plurality of application programs;
an interface module configured to interface between each application program and the plurality of cache levels such that each application program sees the plurality of cache levels as a virtual single cache entity and in which the virtual single cache entity for each application program defines, stores and retrieves multiple instances of data where each instance is associated with a token and each instance can have a specific data structure; and
a storage module configured to store the data instance from each application program to the plurality of cache levels beginning with a first cache level with a lowest order level keyword and with the token for the application program and store the data instance to a cache level with higher order level keyword and the token of the application program when a cache level with a lower order level keyword is filled.

6. The apparatus of claim 5, the storage module further configured to share the data instance in the cache levels stored by a first application program with a second application program by passing the token of the data instance from the first application program to the second application program, wherein the second application program may access the data instance in the cache levels with the token of the first application program.

7. The apparatus of claim 5, wherein each data instance further comprises a structure type that defines a structure of that data instance.

8. The apparatus of claim 7, wherein the structure type is selected from a linked list, a stack, and a flat file structure type.
